(19) United States
(12) Patent Application Publication
(10) Pub. No.: US 2011/0119686 A1
(43) Pub. Date: May 19, 2011

(54) EXTERNAL DATA STORAGE ASSEMBLY INCLUDING A HARD DISK DRIVE AND METHOD OF MONITORING THE OPERATIONAL STATUS OF THE HARD DISK DRIVE

(75) Inventor: Tommy Chen, Taipei (TW)

(73) Assignee: MACPOWER & TYTECH TECHNOLOGY CO., LTD., Taipei County (TW)

(21) Appl. No.: 12/618,065

(22) Filed: Nov. 13, 2009

(51) Int. Cl. G06F 13/00

(52) U.S. Cl. 719/326

(57) ABSTRACT

A method of monitoring the operational status of a hard disk drive in an external data storage assembly is provided. The hard disk drive supports S.M.A.R.T., and the external data storage assembly includes the hard disk drive, a connection interface coupled to a computer host, and an interface bridge interconnecting the connection interface and the hard disk drive. The method includes: (A) when an OS of the computer host identifies the external data storage assembly, enabling the computer host to send a SCSI read command to the connection interface of the external data storage assembly; and (B) enabling the interface bridge to relay the SCSI read command from the connection interface to the hard disk drive such that the hard disk drive transmits S.M.A.R.T. information to the computer host through the interface bridge and the connection interface according to the SCSI read command.

### BACKGROUND OF THE INVENTION

1. Field of the Invention

The present invention relates to a method of enabling a computer host to monitor the operational status of a hard disk device in an external data storage assembly coupled to the computer host. The present invention relates also to the external data storage assembly including the hard disk device that can be so monitored.

2. Description of the Related Art

A hard disk drive generates significant heat as a result of its platters undergoing high-speed rotation, and hence is often used together with a fan for heat dissipation. In some conventional configurations and methods, the rotational speed of the fan is varied in accordance with the temperature of the hard disk drive, such that power consumption and fan noise are minimized and heat dissipation is maximized. To determine the temperature of the hard disk drive in such conventional configurations and methods, a temperature sensor is disposed at a suitable location, and the temperature value obtained by the temperature sensor is read using firmware or software in order to control the rotational speed of the fan.

However, with the use of such a method, not only is an additional component of a temperature sensor required, the temperature of the hard disk drive detected by the temperature sensor is often inaccurate, resulting in sub-optimal cooling of the hard disk drive. In some instances, this may result in damage to the hard disk drive due to overheating.

In view of the drawbacks associated with the above conventional method of detecting the temperature of a hard disk drive and in an effort to better monitor the overall condition of the same, IBM® in 1992 developed a detection technology referred to as S.M.A.R.T. (Self-Monitoring, Analysis, and Reporting Technology) for use in the AS/400 server. S.M.A.R.T. has since been adopted by other computer hardware manufactures, such as Compaq®, and by makers of hard disk drives, such as Seagate®, Quantum®, and Connor®. It is now common for hard disk drives to support S.M.A.R.T.

S.M.A.R.T. allows for self monitoring of hard disk drives such that problems are reported to users at an early stage, thereby allowing users to perform data backup and even replace their hard disk drives. Various characteristics of a hard disk drive are monitored using S.M.A.R.T., such as the temperature of the hard disk drive. Hard disk drives that support S.M.A.R.T. already have built-in temperatures sensors, so a separate temperature is unneeded. Moreover, the S.M.A.R.T. information derived by such built-in temperature sensors accurately reflects the operating temperature of the hard disk drive.

Ever since the S.M.A.R.T. standard has been established, most motherboard manufacturers have already had an option for activating the hard disk drive S.M.A.R.T. built in the BIOS (Basic Input/Output System), and the main operating systems in the market, i.e., the Windows® OS, Mac® OS, and Linux® OS, all provide a corresponding API (Application Programming Interface) or an application program for retrieving S.M.A.R.T. information from an internal hard disk drive that supports S.M.A.R.T.

However, in the case of an external hard disk drive, which typically uses a USB or 1394 connection interface, since the hard disk drive interface thereof (most use the IDE (ATA) or SATA interface) and the connection interface are different, interface conversion must be conducted through a bridgeboard. Therefore, even when the external hard disk drive supports S.M.A.R.T., the present bridgeboard for an external hard disk cannot recognize the command issued by a computer host for reading S.M.A.R.T. information. Furthermore, some operating systems (such as the Mac OS) do not permit a method of directly reading S.M.A.R.T. information from an external hard disk drive, so the S.M.A.R.T. information provided by the external hard disk drive are unable to be used to monitor the operational status of the external hard disk drive.

### SUMMARY OF THE INVENTION

Therefore, the object of the present invention is to provide a method of monitoring the operational status of a hard disk drive in an external data storage assembly using S.M.A.R.T. information generated by the hard disk drive.

Another object of the present invention is to provide a method of monitoring the operational status of a hard disk drive in an external data storage assembly to provide warning messages to a user when needed.

It is yet another object of the present invention to provide an external data storage assembly including a hard disk device that is able to receive SCSI read commands from a computer host and to transmit S.M.A.R.T. information to the computer host in response to the SCSI read command.

According to a first aspect of this invention, there is provided a method of monitoring the operational status of a hard disk drive in an external data storage assembly, the hard disk drive supporting S.M.A.R.T. (Self-Monitoring, Analysis, and Reporting Technology), the external data storage assembly including the hard disk drive, a connection interface coupled to a computer host, and an interface bridge interconnecting the connection interface and the hard disk drive. The method comprises: (A) when an operating system (OS) of the computer host identifies the external data storage assembly, enabling the computer host to send a SCSI (Small Computer System Interface) read command for reading S.M.A.R.T. information to the connection interface of the external data storage assembly; and (B) enabling the interface bridge of the external data storage assembly to relay the SCSI read command from the connection interface to the hard disk drive such that the hard disk drive transmits S.M.A.R.T. information to the computer host through the interface bridge and the connection interface according to the SCSI read command.

According to a second aspect of this invention, an external data storage assembly comprises: a connection interface adapted to be coupled to a computer host and to receive therefrom a SCSI (Small Computer System Interface) read command for reading S.M.A.R.T. (Self-Monitoring, Analysis, and Reporting Technology) information; a hard disk drive which supports S.M.A.R.T. and which performs storage operations according to control by the computer host; and an interface bridge interconnecting the connection interface and the hard disk drive for converting commands between the connection interface and the hard disk drive, and relaying the SCSI read command from the connection interface to the hard disk drive, such that the hard disk drive transmits S.M.A.R.T. information to the computer host through the interface bridge and the connection interface according to the SCSI read command.

According to a third aspect of this invention, a computer program product comprises a computer-readable storage medium that stores an application program for causing a computer host to execute steps of a method with respect to an external storage assembly coupled to the computer host. The method comprises: (A) when an operating system (OS) of the computer host identifies the external data storage assembly, enabling the computer host to send a SCSI (Small Computer System Interface) read command for reading S.M.A.R.T. (Self-Monitoring, Analysis, and Reporting Technology) information to the external data storage assembly; and (B) enabling the computer host to receive S.M.A.R.T. information from the external data storage assembly, and to generate a SCSI control command in response to the S.M.A.R.T. information and send the SCSI control command to the external data storage assembly, such that external data storage assembly performs corresponding control.

According to a fourth aspect of this invention, there is provided a method of monitoring the operational status of a hard disk drive in an external data storage assembly, the hard disk drive supporting S.M.A.R.T. (Self-Monitoring, Analysis, and Reporting Technology), the external data storage assembly including the hard disk drive, a connection interface coupled to a computer host, an interface bridge interconnecting the connection interface and the hard disk drive, and a control unit coupled to the interface bridge. The method comprises: (A) enabling the computer host to obtain information of the remaining capacity of the hard disk drive of the external data storage assembly of the computer host and compare the remaining capacity with a predetermined value, and when the remaining capacity of the hard disk drive is lower than the predetermined value, enabling the computer host to generate a SCSI control command and to send the SCSI control command to the connection interface of the external data storage assembly; and (B) enabling the interface bridge to receive the SCSI control command from the connection interface and transmit the SCSI control command to the control unit, such that the control unit controls the external data storage assembly to generate a warning signal in response to the SCSI control command.

According to a fifth aspect of this invention, an external data storage assembly comprises: a connection interface adapted to be coupled to a computer host and to receive therefrom a SCSI (Small Computer System Interface) control command; a hard disk drive which performs storage operations according to control by the computer host; an interface bridge interconnecting the connection interface and the hard disk drive for converting commands between the connection interface and the hard disk drive, and relaying the SCSI control command; and a control unit electrically connected to the interface bridge to receive the SCSI control command therefrom, and which performs corresponding control. According to a sixth aspect of this invention, a computer program product comprises a computer-readable storage medium that stores an application program for causing a computer host to execute steps of a method with respect to an external storage assembly coupled to the computer host. The method comprises: (A) when an operating system (OS) of the computer host identifies the external data storage assembly, enabling the computer host to obtain information of the remaining capacity of a hard disk drive of the external data storage assembly and compare the remaining capacity with a predetermined value; and (B) when the remaining capacity of the hard disk drive is lower than the predetermined value, enabling the computer host to generate a SCSI control command and to send the SCSI control command to the external data storage assembly, such that the external data storage assembly performs corresponding control.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic circuit block diagram of an external data storage assembly in accordance with a preferred embodiment of the present invention, illustrating the external data storage assembly in a state coupled to a computer host;

FIG. 2 is a flowchart of the steps involved in the computer host reading S.M.A.R.T. information from the external data storage assembly and then controlling the external data storage assembly according to the S.M.A.R.T. information in accordance with a preferred embodiment of the present invention; and

FIG. 3 is a flowchart of the steps involved in the computer host generating a warning message notifying a user of the low remaining capacity of an external hard disk drive of the external data storage assembly in accordance with a preferred embodiment of the present invention.

### DETAILED DESCRIPTION OF THE PREFERRED EMBODIMENT

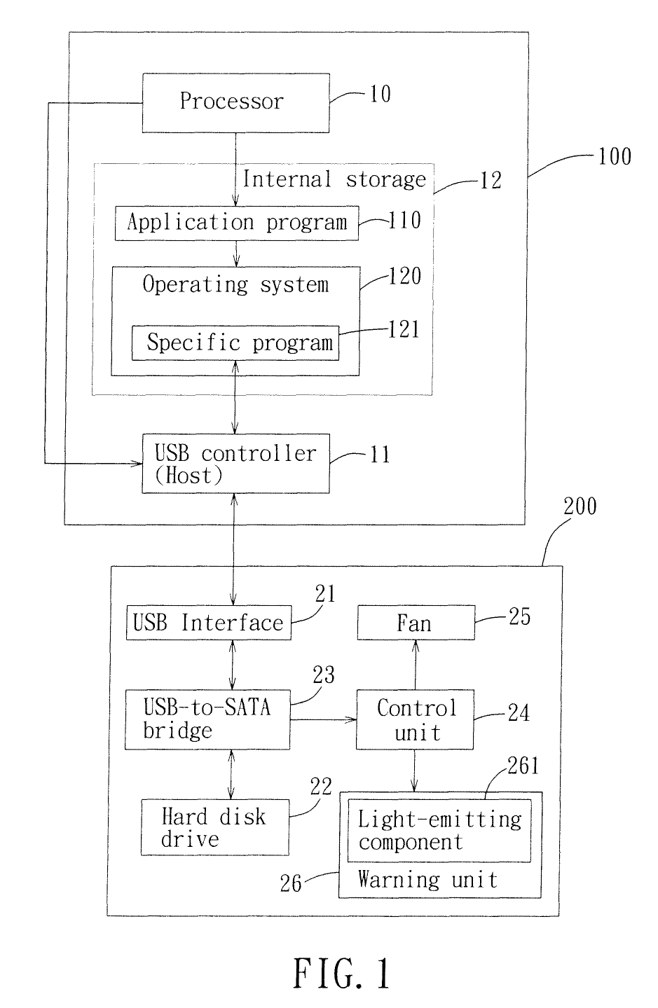

Referring to FIG. 1, an external data storage assembly 200 according to a preferred embodiment of the present invention comprises a connection interface 21, a hard disk drive 22, an interface bridge 23, a control unit 24, a fan 25, and a warning unit 26.

In some embodiments, the connection interface 21 is of a USB interface and a 1394 interface. In this embodiment, the connection interface 21 is a USB (Universal Serial Bus) interface. The USB interface 21 is adapted to be coupled to a computer host 100.

The hard disk drive 22 supports S.M.A.R.T. In some embodiments, the hard disk drive 22 has one of an IDE (ATA) and SATA interface. In this embodiment, the hard disk drive 22 uses a SATA interface.

The interface bridge 23 interconnects the USB interface 21 and the hard disk drive 22. In some embodiments, the interface bridge 23 is one of USB-to-ATA, USB-to-SATA, 1394-to-ATA, and 1394-to-SATA interface bridge. In this embodiment, a USB-to-SATA bridge is used. The USB-to-SATA bridge 23 is a controller used to convert commands between the SATA interface of the hard disk drive 22 and the USB interface 21 connected to the computer host 100.

The control unit (MCU) 24 is connected electrically to the USB-to-SATA bridge 23, as well as to the fan 25 and the warning unit 26.

The fan 25 is electrically connected to the control unit 24 (as described above), and is controlled by the control unit 24 to operate at specific rotational speeds.

Since the hard disk drive 22 supports S.M.A.R.T., when the hard disk drive 22 operates, the hard disk drive 22 self-monitors and records S.M.A.R.T. information including the operating temperature of the hard disk drive 22. In particular, in this embodiment, the USB-to-SATA bridge 23 of the external data storage assembly 200 is programmed to be able to receive an SCSI command defined by an ATA pass through format for reading S.M.A.R.T. information to pass therethrough before reaching the hard disk drive 22.

Moreover, in order to realize the method of this invention, the computer host 100 of this embodiment further includes an internal storage 12 that stores an application program 110 for enabling the computer host 100 to read the S.M.A.R.T. information from the external data storage assembly 200. When the computer host 100 is started and loads an operating system (OS) 120 to a processor 10, the operating system 120 may further load the application program 110 to the processor 10 in response to user operation to execute the function of reading the S.M.A.R.T. information of the external data storage assembly 200. The application program 110 can be executed in different operating systems, such as the Windows® OS, Mac® OS, Linux® OS, etc.

In the following, an example is given of a procedure of the application program 110 enabling the processor 10 to read the S.M.A.R.T. information from the external data storage assembly 200 in a Windows® or Linux® OS environment, and this example is used to describe how the application program 110 is used to control the fan 25 of the external data storage assembly 200 according to S.M.A.R.T. information of the hard disk drive 22.

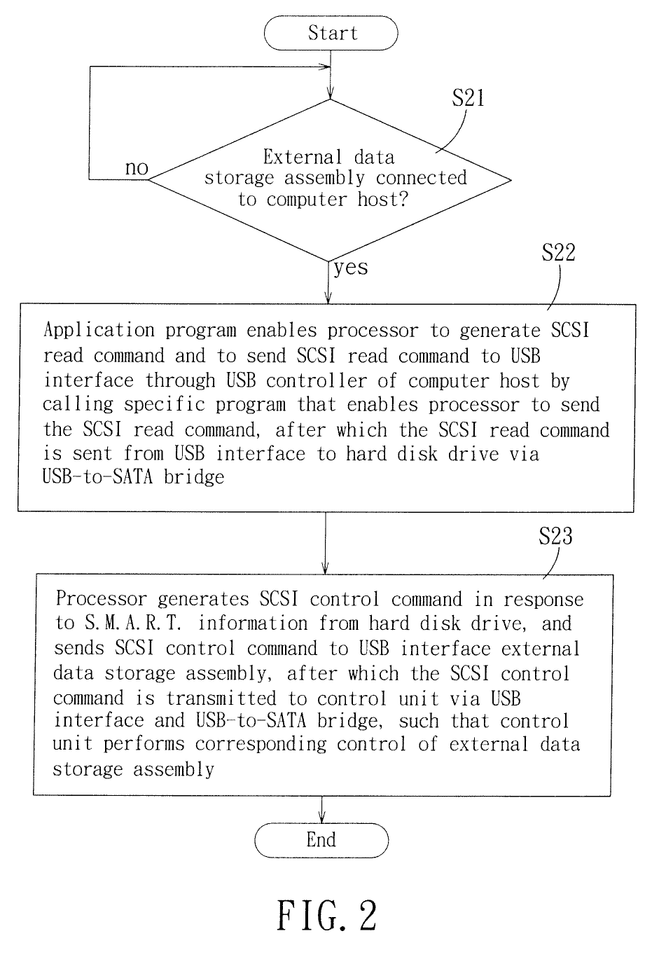

Referring to FIG. 2, when the application program 110 is executed, in step S21, the application program 110 enables the processor 10 to determine whether there is an external peripheral device (such as the external data storage assembly 200) connected to the computer host 100 by querying the operating system 120, and if there is, enables the processor 10 to acquire an external storage apparatus ID in the operating system 120 for the external data storage assembly 200, such as \\.\PhysicalDrive1 in Microsoft Windows, etc., so as to know the location and connection path of the external data storage assembly 200.

Next, in step 22, in response to a user request, the application program 110 enables the processor 10 to generate a SCSI read command for reading S.M.A.R.T. information from the hard disk drive 22. The SCSI read command includes a command, which is defined by an ATA_pass_through format, for reading S.M.A.R.T. information. Since the Windows® or Linux® operating system provides a specific program 121 to send an SCSI command (i.e., a function call, also referred to as a system function), the application program 110 enables the processor 10 to send the SCSI read command for reading S.M.A.R.T. information of the hard disk drive 22 to the USB interface 21 of the external data storage assembly 200 through a USB controller (Host) 11 of the computer host 100 by calling the specific program 121 (function) that enables the processor 10 to send the SCSI read command. That is, in some embodiments where the OS 120 is a Windows or Linux® OS, the specific program 121 is a standard function provided by the OS 120.

In other embodiments where the OS 120 is a Mac® OS, the specific program 121 is a kernel-extended driving program. Since the Mac® OS does not provide a specific function for reading S.M.A.R.T. information, a specific program 121 has to be developed for the Mac® OS, that is, a kernel-extended driving program for transmitting SCSI commands generated through the application program 110 (including the SCSI read command for reading S.M.A.R.T. information-defined in an ATA_pass_through format—of the external data storage assembly 200, the SCSI control command for controlling fan rotational speed, and the SCSI control command for controlling the warning signal generation).

At this time, since the USB-to-SATA bridge 23 has been programmed to permit the SCSI command in an ATA_pass_through format to pass therethrough, the SCSI read command for reading the S.M.A.R.T. information of the hard disk drive 22 is further able to be sent from the USB interface 21 to the hard disk drive 22 via the USB-to-SATA bridge 23. Therefore, after the hard disk drive 22 receives the SCSI read command for reading the S.M.A.R.T. information, the S.M.A.R.T. information is sent to the processor 10 from the hard disk drive 22 along the same transmission path according to the designation of the SCSI read command.

Since the operation for obtaining the S.M.A.R.T. status of the hard disk drive 22 (including detection of the temperature of the hard disk drive 22) is performed entirely by an internal controller of the hard disk drive 22 supporting S.M.A.R.T., these aspects of S.M.A.R.T. are not further detailed.

In step 23, the processor 10 generates a SCSI control command in response to the S.M.A.R.T. information from the hard disk drive 22, and sends the SCSI control command to the USB interface 21 of the external data storage assembly 200. The SCSI control command is then transmitted to the control unit 24 via the USB interface 21 and the USB-to-SATA bridge 23, such that the control unit 24 performs corresponding control of the external data storage assembly 200.

When the S.M.A.R.T. information transmitted to the processor 10 from the hard disk drive 22 is the operating temperature of the hard disk drive 22, the SCSI control command of step 23 is that generated according to the operating temperature of the hard disk drive 22, and the control unit 24 controls the rotational speed of the fan 25 according to the SCSI control command.

In some embodiments, a lookup table between the rotational speed of the fan 25 and the operating temperature of the hard disk drive 22 is established, for example, in the application program 110, and, in step 23, the processor 10 generates the SCSI control command in response to the S.M.A.R.T. information from the hard disk drive 22 and with reference to the lookup table.

In some embodiments, the hard disk drive 22 has an IDE (ATA) interface or a SATA interface, and in step 22, the USB-to-SATA bridge 23 converts the SCSI read command from one of a USB and a 1394 format to one of an IDE(ATA) and a SATA format before relaying the SCSI read command to the hard disk drive 22, and in step 23, the USB-to-SATA interface bridge 23 converts the SCSI control command from one of a USB and a 1394 format to one of an IDE(ATA) and a SATA format before relaying the SCSI control command to the control unit 24.

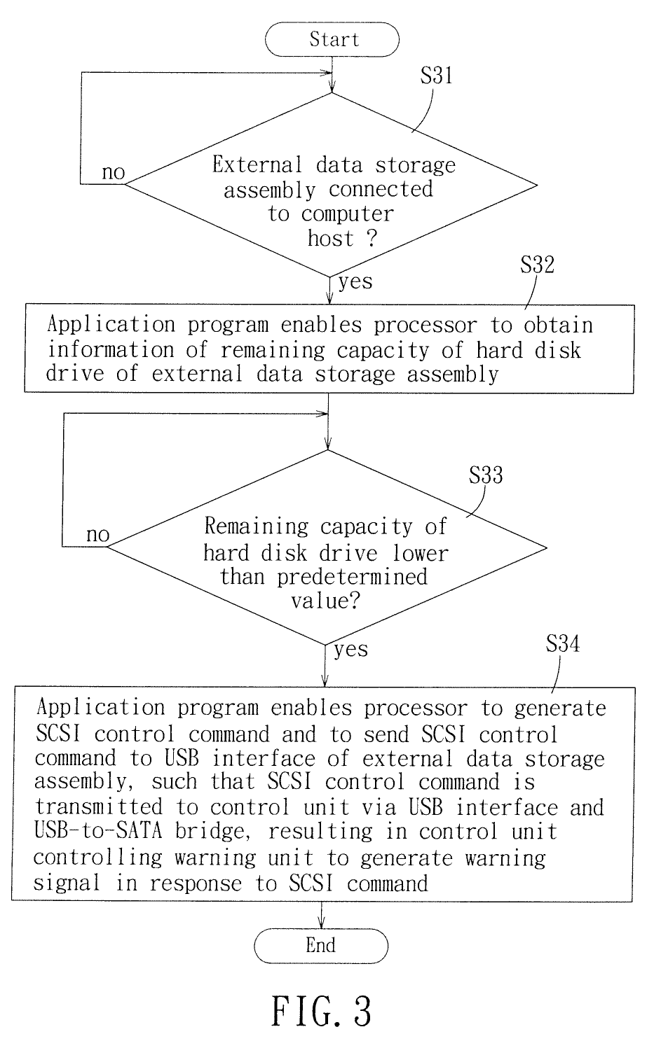

With reference to FIG. 3, in this embodiment, the remaining capacity of the hard disk drive 22 is determined, and the user is notified when the remaining capacity reaches a certain low level (i.e., is lower than a predetermined value). In this embodiment, the warning unit 26 includes a light-emitting component 261 which maybe disposed on a housing (not shown) of the external data storage assembly 200.

Further, in this embodiment, the application program 110 enables the processor 10 to perform control such that the user is provided with various options of selecting the predetermined value with which the remaining capacity of the hard disk drive 22 is compared. For example, the processor 10 may perform control to allow the user to select 5%, 10%, or 15% as the predetermined value, and when the remaining capacity of the hard disk drive 22 is reduced to below one of these values, the user is notified of this fact. In some embodiments, the predetermined value is preset by the vendor.

First, in step 31, the application program 110 enables the processor 10 to determine whether the external data storage assembly 200 is connected to the computer host 100. In this step and in step 21 of the previous embodiment, this may involve the processor 10 determining whether the OS 120 identifies the external data storage assembly 200. In some embodiments, the OS 120 of the computer host 100 identifies the external data storage assembly 200 when the computer host 100 detects an external data storage device ID corresponding to the external data storage assembly 200 in the OS 120, such as \\.\PhysicalDrive1 in Microsoft Windows, etc.

Next, in step 32, the application program 110 enables the processor 10 to obtain information of the remaining capacity of the hard disk drive 22 of the external data storage assembly 200. In some embodiments, the application program 110 enables the processor 10 to query the operating system 120 at set times for the remaining capacity of the hard disk drive 22.

Next, in step S33, the application program 110 enables the processor 10 to determine whether the remaining capacity of the hard disk drive 22 is lower than the predetermined value.

In step 34, when the remaining capacity of the hard disk drive 22 is lower than the predetermined value, the application program 110 enables the processor 10 to generate a SCSI control command and to send the SCSI control command to the USB interface 21 of the external data storage assembly 200, such that the SCSI control command is transmitted to the control unit 24 via the USB interface 21 and the USB-to-SATA bridge 23. As a result, the control unit 24 controls the warning unit 26 to generate a warning signal in response to the SCSI command. In this embodiment, the warning signal is light generated through the light-emitting component 261 of the warning unit 26. In other embodiments, the warning signal may be sound or text, in which case the warning unit 26 includes the appropriate components to emit sound, text, etc., and the present invention is not limited in this regard.

In some embodiments, the SCSI control command generated by the processor 10 is such that different warning signals are generated depending on the remaining capacity of the hard disk drive 22. For example, in this embodiment where the warning unit 26 includes the light-emitting component 261 and the warning signal is light generated thereby, the processor 10 may perform control such that different colors or different flashing patterns are generated by the light-emitting component depending on the remaining capacity of the hard disk drive 22. For instance, when the remaining capacity of the hard disk drive 22 falls below 30%, a yellow light or a single flash pattern may be shown, and when the remaining capacity of the hard disk drive 22 falls below 10%, a red light or a double flash pattern may be shown. Hence, the user can timely take appropriate measures as needed, such as deleting unimportant files to free up space, backing up important files before deletion of the same, and even replacing the external data storage assembly 200.

In the present invention described above, the USB-to-SATA bridge 23 of the external data storage assembly 200 supports SCSI commands defined in an ATA_pass_through format to pass therethrough to reach the hard disk drive 22, so that the computer host 100 is able to generate a SCSI read command for reading the S.M.A.R.T. information of the external hard disk assembly 200. Also, by calling a function of the operating system 120 or a driving program separately developed, the computer host 100 sends the SCSI read command to the hard disk drive 22 through the USB interface 21 and the USB-to-SATA bridge 23 of the external data storage assembly 200, so that the hard disk drive 22 can send the S.M.A.R.T. information back to the computer host 100. Therefore, the computer host 100 can obtain the operational status of the external data storage assembly 200 which may then be reported to the user to allow him or her to take appropriate measures. Moreover, in addition to the operating temperature of the hard disk drive 22, the S.M.A.R.T. information may include other status data of the hard disk drive 22, such as the number of on and off switching operations, total use time, the number of reading errors, head flying height, spin-up time, data throughput, etc. Hence, the user may be provided with various S.M.A.R.T. alerts that allow him or her to take actions to protect the data stored in the hard disk drive 22.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method of monitoring the operational status of a hard disk drive in an external data storage assembly, the hard disk drive supporting S.M.A.R.T. (Self-Monitoring, Analysis, and Reporting Technology), the external data storage assembly including the hard disk drive, a connection interface coupled to a computer host, and an interface bridge interconnecting the connection interface and the hard disk drive, said method comprising:
(A) when an operating system (OS) of the computer host identifies the external data storage assembly, enabling the computer host to send a SCSI (Small Computer System Interface) read command for reading S.M.A.R.T. information to the connection interface of the external data storage assembly; and
(B) enabling the interface bridge of the external data storage assembly to relay the SCSI read command from the connection interface to the hard disk drive such that the hard disk drive transmits S.M.A.R.T. information to the computer host through the interface bridge and the connection interface according to the SCSI read command.

2. The method of claim 1, wherein, in step (A), the OS of the computer host identifies the external data storage assembly when the computer host detects an external storage device ID corresponding to the external data storage assembly in the OS.

3. The method of claim 1, wherein, in step (A), an application program in an internal storage device of the computer host enables a processor of the computer host to call a specific program that enables the processor to send the SCSI read command, the specific program being a standard function provided by the OS.

4. The method of claim 1, wherein, in step (A), an application program in an internal storage of the computer host enables a processor of the computer host to call a specific program that enables the processor to send the SCSI read command, the specific program being a kernel-extended driving program.

5. The method of claim 1, the external data storage assembly further including a control unit connected electrically to the interface bridge, said method further comprising:
(C) enabling the computer host to generate a SCSI control command in response to the S.M.A.R.T. information from the hard disk drive, and to send the SCSI control command to the connection interface of the external data storage assembly, such that the SCSI control command is transmitted to the control unit via the connection interface and the interface bridge, and such that the control unit performs corresponding control of the external data storage assembly.

6. The method of claim 5, the external data storage assembly further including a fan electrically connected to the control unit, wherein, instep (B), the S.M.A.R.T. information transmitted to the computer host from the hard disk drive includes an operating temperature of the hard disk drive, and in step (C), the SCSI control command is generated by the computer host according to the operating temperature of the hard disk drive, and the control unit controls a rotational speed of the fan according to the SCSI control command.

7. The method of claim 5, the hard disk drive having one of an IDE (ATA) interface and a SATA interface, wherein, instep (B), the interface bridge converts the SCSI read command from one of a USB and a 1394 format to one of an IDE (ATA) and a SATA format before relaying the SCSI read command to the hard disk drive, and in step (C), the interface bridge converts the SCSI control command from one of a USB and a 1394 format to one of an IDE(ATA) and a SATA format before relaying the SCSI control command to the control unit.

8. The method of claim 1, the external data storage assembly further including a control unit connected electrically to the interface bridge, said method further comprising:
(C) enabling the computer host to obtain information of the remaining capacity of the hard disk drive of the external data storage assembly and compare the remaining capacity with a predetermined value, and when the remaining capacity of the hard disk drive is lower than the predetermined value, enabling the computer host to generate a SCSI control command and to send the SCSI control command to the connection interface of the external data storage assembly, such that the SCSI control command is transmitted to the control unit via the connection interface and the interface bridge, and such that the control unit controls the external data storage assembly to generate a warning signal in response to the SCSI control command.

9. The method of claim 8, wherein the warning signal is a visible signal.

10. An external data storage assembly comprising:
a connection interface adapted to be coupled to a computer host and to receive therefrom a SCSI (Small Computer System Interface) read command for reading S.M.A.R.T. (Self-Monitoring, Analysis, and Reporting Technology) information;
a hard disk drive which supports S.M.A.R.T. and which performs storage operations according to control by the computer host; and
an interface bridge interconnecting said connection interface and said hard disk drive for converting commands between said connection interface and said hard disk drive, and relaying the SCSI read command from said connection interface to said hard disk drive, such that said hard disk drive transmits S.M.A.R.T. information to the computer host through said interface bridge and said connection interface according to the SCSI read command.

11. The external data storage assembly of claim 10, further comprising a control unit connected electrically to said interface bridge, said interface bridge transmitting a SCSI control command from the computer host to said control unit, such that said control unit performs corresponding control of said external data storage assembly.

12. The external data storage assembly of claim 11, further comprising a fan electrically connected to said control unit, the SCSI control command being a fan speed control command, such that said control unit controls a rotational speed of said fan according to the SCSI control command.

13. The external data storage assembly of claim 10, wherein said connection interface is one of a USB and a 1394 interface, and said interface bridge is one of USB-to-ATA, USB-to-SATA, 1394-to-ATA, and 1394-to-SATA interface bridge, and said hard disk drive has one of an IDE(ATA) and SATA interface.

14. The external data storage assembly of claim 10, further comprising a control unit connected electrically to said interface bridge, and a warning unit electrically connected to said control unit, said interface bridge receiving a SCSI control command from the computer host and transmitting the SCSI control command to said control unit, such that said control unit controls said warning unit to emit a warning signal.

15. The external data storage assembly of claim 14, wherein said warning unit includes a light-emitting component disposed on a housing of the external data storage assembly, the warning signal being light emitted by the light-emitting component.

16. A computer program product comprising a computer-readable storage medium that stores an application program for causing a computer host to execute steps of a method with respect to an external storage assembly coupled to the computer host, said method comprising:
(A) when an operating system (OS) of the computer host identifies the external data storage assembly, enabling the computer host to send a SCSI (Small Computer System Interface) read command for reading S.M.A.R.T. (Self-Monitoring, Analysis, and Reporting Technology) information to the external data storage assembly; and
(B) enabling the computer host to receive S.M.A.R.T. information from the external data storage assembly, and to generate a SCSI control command in response to the S.M.A.R.T. information and send the SCSI control command to the external data storage assembly, such that external data storage assembly performs corresponding control.

17. The computer program product of claim 16, wherein, in step (A), the application program enables the computer host to call a specific program that enables the computer host to send the SCSI read command, the specific program being a standard function provided by the OS.

18. The computer program product of claim 16, wherein, in step (A), the application program enables the computer host to call a specific program that enables the computer host to send the SCSI read command, the specific program being a kernel-extended driving program.

19. A method of monitoring the operational status of a hard disk drive in an external data storage assembly, the hard disk drive supporting S.M.A.R.T. (Self-Monitoring, Analysis, and Reporting Technology), the external data storage assembly including the hard disk drive, a connection interface coupled to a computer host, an interface bridge interconnecting the connection interface and the hard disk drive, and a control unit coupled to the interface bridge, said method comprising:
(A) enabling the computer host to obtain information of the remaining capacity of the hard disk drive of the external data storage assembly of the computer host and compare the remaining capacity with a predetermined value, and when the remaining capacity of the hard disk drive is lower than the predetermined value, enabling the computer host to generate a SCSI control command and to send the SCSI control command to the connection interface of the external data storage assembly; and
(B) enabling the interface bridge to receive the SCSI control command from the connection interface and transmit the SCSI control command to the control unit, such that the control unit controls the external data storage assembly to generate a warning signal in response to the SCSI control command.

20. The method of claim 19, wherein the warning signal is a visible signal.

21. An external data storage assembly comprising:
a connection interface adapted to be coupled to a computer host and to receive therefrom a SCSI (Small Computer System Interface) control command;
a hard disk drive which performs storage operations according to control by the computer host;
an interface bridge interconnecting said connection interface and said hard disk drive for converting commands between said connection interface and said hard disk drive, and relaying the SCSI control command; and
a control unit electrically connected to said interface bridge to receive the SCSI control command therefrom, and which performs corresponding control.

22. The external data storage assembly of claim 21, further comprising a warning unit electrically connected to said control unit, said control unit controlling said warning unit to generate a warning signal according to the SCSI control command.

23. The external data storage assembly of claim 22, wherein the warning unit includes a light-emitting component disposed on a housing of the external data storage assembly, the warning signal being light emitted by the light-emitting component.

24. A computer program product comprising a computer-readable storage medium that stores an application program for causing a computer host to execute steps of a method with respect to an external storage assembly coupled to the computer host, said method comprising:
(A) when an operating system (OS) of the computer host identifies the external data storage assembly, enabling the computer host to obtain information of the remaining capacity of a hard disk drive of the external data storage assembly and compare the remaining capacity with a predetermined value; and
(B) when the remaining capacity of the hard disk drive is lower than the predetermined value, enabling the computer host to generate a SCSI control command and to send the SCSI control command to the external data storage assembly, such that the external data storage assembly performs corresponding control.

25. The computer program product of claim 24, wherein, instep (A), the application program enables the computer host to call a specific program that enables the computer host to obtain information of the remaining capacity of the hard disk drive of the external data storage assembly, the specific program being a standard function provided by the OS.

26. The computer program product of claim 24, wherein, instep (A), the application program enables the computer host to call a specific program that enables the computer host to obtain information of the remaining capacity of the hard disk drive of the external data storage assembly, the specific program being a kernel-extended driving program.
